(19) United States
(12) Patent Application Publication
(10) Pub. No.: US 2014/0138036 A1
(43) Pub. Date: May 22, 2014

(54) TENSIONED VENETIAN BLIND SYSTEM

(71) Applicants: Ruben H. J. de Vries, Zevenaar (NL); Bastiaan F. Klein Tuente, Groenlo (NL); Thomas J.M. Ter Haar, Hengelo (NL); Harry Davids, Raalte (NL)

(72) Inventors: Ruben H. J. de Vries, Zevenaar (NL); Bastiaan F. Klein Tuente, Groenlo (NL); Thomas J.M. Ter Haar, Hengelo (NL); Harry Davids, Raalte (NL)

(21) Appl. No.: 14/084,457

(22) Filed: Nov. 19, 2013

(30) Foreign Application Priority Data
Nov. 22, 2012 (NL) 2009861

(51) Int. Cl. E06B 9/307

(52) U.S. Cl. CPC E06B 9/307
USPC 160/176.1 R

(57) ABSTRACT

The invention relates to a tensioned Venetian blind system comprising a head rail (2) and a bottom rail, between which ladder cords extend, wherein slats are accommodated. In the rails tension cords (4) extend for fastening to a surface. Furthermore in the head rail (2) a tilt rod (7) extends for tilting the slats. In the head rail a tilt mechanism is arranged for adjusting the orientation of the slats by rotating the tilt rod. The tilt mechanism comprises a housing (11) having a passage for the tilt rod. The housing is arranged for guiding the tension cords.

### TECHNICAL FIELD

The present invention relates to a tensioned Venetian blind system comprising a head rail and a bottom rail, between which ladder cords extend, wherein slats are accommodated, wherein tension cords extend in the rails for fastening to a surface.

### BACKGROUND OF THE INVENTION

Tensioned window covering has the advantage that the rails are movable along the tension cords by which the window covering can always be adjusted in the most optimal orientation. Tensioned window covering is known in the market in a variety of forms among which is a tensioned Venetian blind system.

A tensioned Venetian blind system according to the preamble is for example known from EP 2216484.

In the known tensioned Venetian blind system tailoring, and especially shortening the rail, is a complicated task that is performed by experts. The known tensioned Venetian blind system consequently is only offered in customized form, i.e. it is customized in advanced in the factory or on-site.

### SUMMARY OF THE INVENTION

It is an object of the present invention to provide a tensioned pleated blind system that is suitable for the do-it-yourself-market.

The tensioned pleated blind system according to the invention is characterized in that further in at least one of the rails a tilt rod extends for fastening of the ladder cords, wherein in the rail, preferably between the ladder cords, a tilt mechanism is arranged for adjusting the orientation of the slats by rotating the tilt rod, which tilt mechanism comprises a housing that is arranged for engaging the tilt rod, wherein the housing is arranged for guiding the tension cords.

Thanks to the choice for a tilt rod and guidance of the tension cords through the housing of the tilt mechanism, the tilt mechanism can be arranged at almost any desired position in the rail and consequently the rail can easily be shortened to the desired size.

Preferably the housing is arranged for guiding the tension cords near the bottom of the rail. The tension cords are pushed slightly downwards by the housing and are thereby diverted only over a minimum distance. The tensioned Venetian blind system according to the invention hereby obtains an optimal tension cord diversion thereby avoiding as much as possible the occurrence of damage to the tension cords as a consequence of using the tilt mechanism. Additionally this tension cord diversion along the underside of the tilt mechanism leads to a compact design of the tilt mechanism by which the use of a rail with relative small cross section is made possible.

According to a first preferred embodiment the housing comprises two cooperating parts for enclosure of the tension cords, wherein the first housing part is arranged for guiding the tension cords along the underside thereof and wherein the second housing part is arranged for guiding the tension cords along the upper side thereof. Due to the enclosure a friction force is exerted on the tension cords, that somewhat relieves the spring and the tension cords of carrying the weight of the tensioned Venetian blind system.

In a practical preferred embodiment the head rail is provided with an aperture at the location of the tilt mechanism wherein the second housing part is releasably attachable to the head rail for closing the aperture. This practical preferred embodiment is especially of advantage with a special type of rail having an elevated bottom, whereby a free space is present beneath the bottom and between the sides of the rail. This free space largely conceals the closure element.

In an optimally balanced preferred embodiment in the rails one or more friction components are arranged for guiding the tension cords, wherein the friction components are provided with a second housing, comprising a third and a fourth cooperating housing part releasably attachable to each other for enclosure of the tension cords, wherein the third housing part is arranged for guiding the tension cords along the underside thereof and wherein the fourth housing part is arranged for guiding the tension cords along the upper side thereof. The enclosure of the tension cords between the housing parts of the friction components enlarges the friction on the tension cords. This relieves the tension cords and the springs connected thereto further of the weight of the tensioned Venetian blind system and as a consequence they will be less subject to wear.

A further preferred embodiment offers optimal guidance of the tension cords because the housing parts are provided with one or more roll axes for guiding the tension cords. The guidance of the tension cords is even further improved in the preferred embodiment wherein the cooperating housing parts are complementarily shaped. According to a further elaboration the cooperating housing parts are generally wedge-shaped.

In an elegant preferred embodiment a transmission is arranged in the housing of the tilt mechanism, comprising a cooperating worm and worm wheel, wherein the worm wheel is arranged on the tilt rod and wherein the tilt mechanism comprises means for operating the worm.

In an economical preferred embodiment the operating means comprises a button that preferably is releasably attachable to the tilt mechanism. This preferred embodiment leads to a variety of savings, among which are savings in packaging costs and consequently also in transport and storage costs.

According to an optimal preferred embodiment having a maximum cuttable rail the tension cords run between the head rail and the bottom rail via through holes in the slats at the position of the ladder cords.

### BRIEF DESCRIPTION OF THE DRAWINGS

The present invention will now further be elucidated with reference to the figures, wherein:

FIG. 1 shows a schematic view of a tensioned Venetian blind system according to the invention;

FIG. 2 shows a schematic view of a part of the head rail of the system of FIG. 1;

FIG. 3 schematically shows a partial view of FIG. 2 from a different point of view;

FIG. 4 shows the partial view of FIGS. 2 and 3 in cross section;

FIG. 5 shows the partial view of FIG. 2 in an exploded view; and

FIGS. 6A and 6B show an additional friction component with exploded parts respectively in a position of use.

### BEST MODE FOR CARRYING OUT THE INVENTION

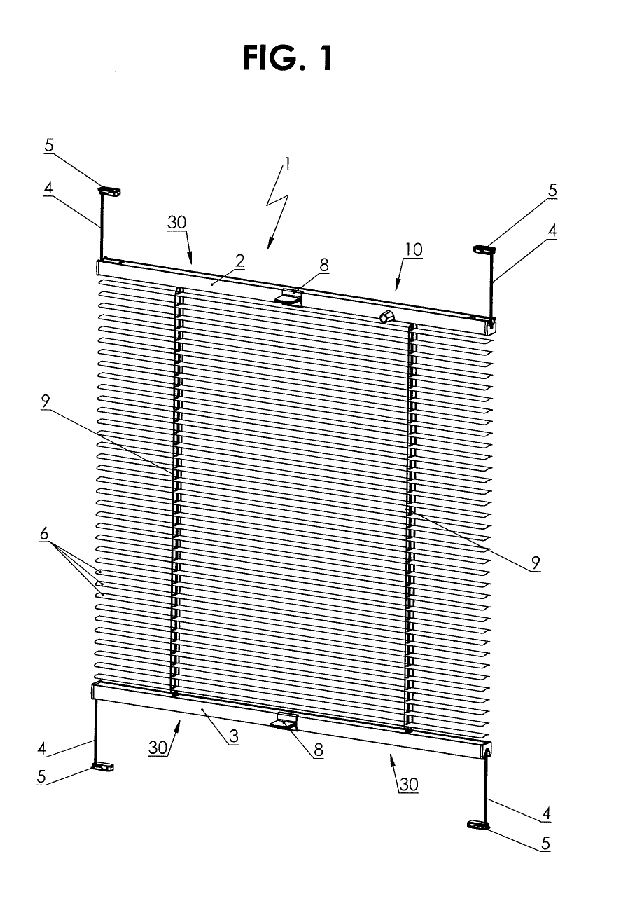

FIG. 1 shows a tensioned Venetian blind system 1 according to the invention in schematic view. Venetian blind system 1 comprises a head rail 2 and a bottom rail 3, wherein between ladder cords 9 extend, wherein slats 6 are accommodated. Tension cords 4 run in the rails 2, 3. The tension cords 4 run between the head rail 2 and the bottom rail 3 through holes at the position of the ladder cords 9 in the slats 6. Fastening means 5, for example, tensioning shoes, are provided for fastening the tension cords 4 to a surface, for example a surface of a window frame. Each of the rails is provided with an operation handle 8 for moving the rail along tension cords 4. A tilt rod 7 extends parallel to the tension cords 4 in rail 2. A tilt mechanism 10 is provided on head rail 2 for adjusting the orientation of the slats 6 by rotation of the tilt rod.

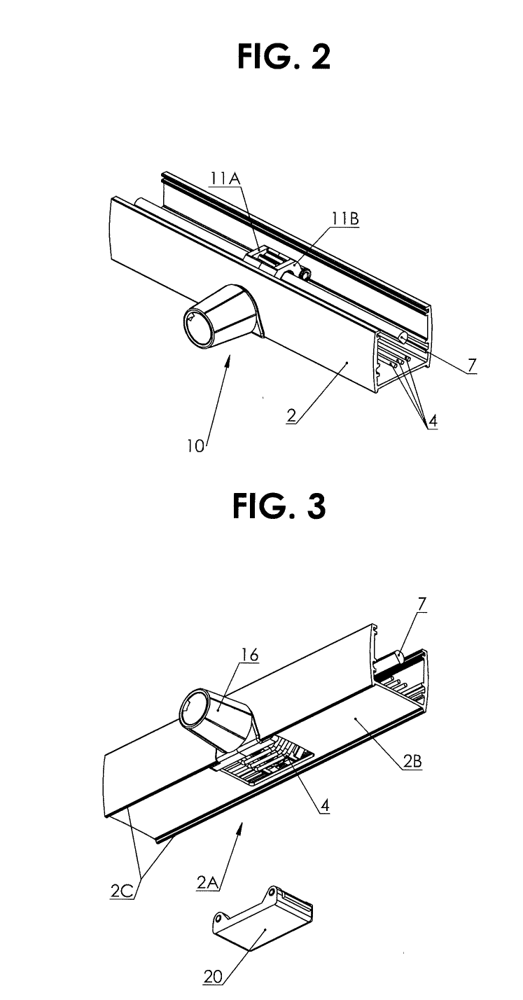

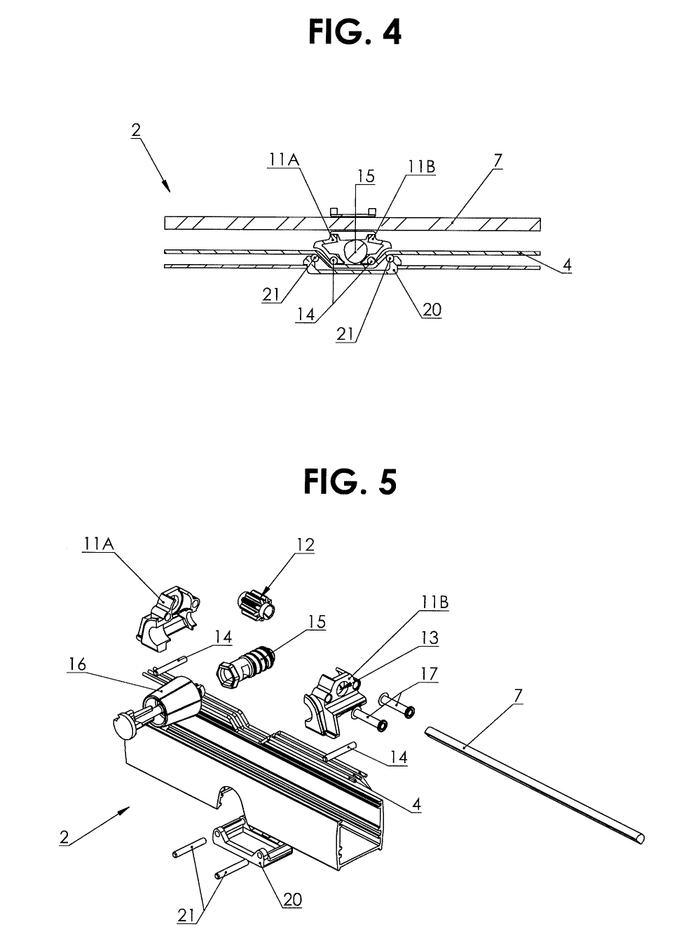

FIGS. 2 through 5 schematically show a partial view of rail 2 with tilt mechanism 10 from different viewpoints and in cross section and in exploded view.

Tilt mechanism 10 has a first housing part 11, which is provided with a passage 13 for the tilt rod 7. For the purpose of mounting the first housing part 11 preferably consists of two components 11A and 11 B that enclose a transmission 12, 15. The transmission is preferably formed by a worm wheel 12 that is arranged on tilt rod 7, and a worm 15 for driving the worm wheel 12. An operation button 16 extends in line with the worm 15 for operating the worm wheel transmission.

The tilt mechanism 10 serves to adjust the orientation of the slats 6 by rotating the tilt rod 7.

Fastening means 17 serve for fastening the components 11A and 11 B to each other. Preferably these fastening means comprise pins 17.

According to the invention the first housing part 11 is arranged for guiding the tension cords 4 along the underside of the housing part 11. The first housing part 11 presses the tension cords 4 somewhat in the direction of the underside of rail 2 and thus ensures a minimal diversion of the tension cords 4 without damaging them. Guiding elements, such as roll axes 14, are present on diversion points near the underside of first housing part 11 for guiding the tension cord 4. The shape of the underside of the first housing part 11 is generally wedge-shaped.

In rail 2 an aperture 2A is arranged, that is present in the underside of the rail 2 at the position of the tilt mechanism 10. According to the invention a second housing part 20 is provided, that is releasably attachable in the aperture 2A for closing it. In the embodiment shown rail 2 at the underside has a free space that extends under the bottom 2B of rail 2 and between the sides 2C of rail 2. In this free space the second housing part 20 can be concealed.

The second housing part 20 is arranged for guiding the tension cords 4 along the upper side of the second housing part. Second housing part 20 and first housing part 11 have a complementary shape and enclose the tension cords. The shape of the upper side of second housing part 20 is preferably generally wedge-shaped. The second housing part 20 is on both sides at diversion points provided with guiding elements, such as roll axes 21, for an optimal guidance of the tension cords 4.

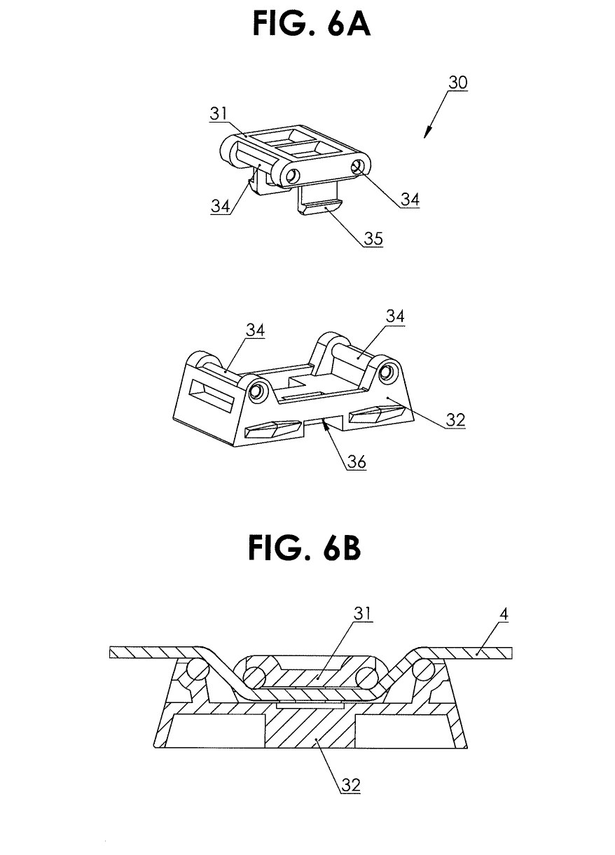

In the head rail 2 and in the bottom rail 3 further one or more friction components 30 are arranged for guiding the tension cords 4. The friction component 30 can be fastened at any desired position in the rail. In FIG. 1 three preferred positions for the friction components are marked. FIGS. 6A and 6B show a schematic view of an additional friction component 30 with exploded parts respectively in position of use.

Each friction component 30 is provided with a housing comprising a third and a fourth cooperating housing part 31 respectively 32, for enclosure of the tension cords 4. The third housing part 31 is arranged for guiding the tension cords along the underside thereof and the fourth housing part 32 is arranged for guiding the tension cords along the upper side thereof.

Third housing part 31 and forth housing part 32 have a complementary shape and enclose the tension cords.

The third housing part 31 presses the tension cords 4 somewhat in the direction of the underside of fourth housing part 32 and thus ensures a minimal diversion of the tension cords 4 without damaging them. Guiding elements, such as roll axes 34, are present at diversion points near the underside of third housing part 31 for guiding the tension cords 4. The shape of the underside of the third housing part 31 is generally wedge-shaped.

The shape of the upper side of fourth housing part 32 preferably is generally wedge-shaped. The fourth housing part 32 is on both sides at diversion points provided with guiding elements, such as roll axes 34, for an optimal guidance of the tension cords 4. The fourth housing part 32 is arranged to be releasably attached in the rails, preferably by means of clamping.

The third and fourth housing parts are releasably attachable to each other, for example by means of a snap connection. In the preferred embodiment shown the snap connection comprises a resilient lip 35 and a recess 36 for reception of the lip.

In the preferred embodiment shown and described the tilt mechanism is arranged in the head rail 2. It will be clear that the tilt mechanism can, if so desired, also be arranged in the bottom rail 3. In the preferred embodiment shown both the head rail and the bottom rail 3 are movable. It will be clear that this is not necessary and that the tilt mechanism 10 according to the invention can also be applied in a tensioned Venetian blind system having one movable rail. Further modifications of the preferred embodiment, that fall under the inventive thought, are conceivable, for example the use of more tilt rods running in line.

The invention is not therefore limited to the described and shown preferred embodiments, but extends to any embodiment falling within the scope of protection as defined in the claims and as seen in the light of the foregoing description and accompanying drawings.

1. A tensioned Venetian blind system comprising a head rail and a bottom rail, between which ladder cords extend, wherein slats are accommodated, wherein tension cords extend in the rails for fastening to a surface, characterized in that, further in at least one of the rails a tilt rod extends for fastening of the ladder cords, wherein in the rail, preferably between the ladder cords, a tilt mechanism is arranged for adjusting the orientation of the slats by rotating the tilt rod, which tilt mechanism comprises a housing that is arranged for engaging the tilt rod, wherein the housing is arranged for guiding the tension cords.

2. A tensioned Venetian blind system according to claim 1, wherein the housing is arranged for guiding the tension cords near the bottom of the rail.

3. A tensioned Venetian blind system according to claim 1, wherein the housing comprises two cooperating parts for enclosure of the tension cords, wherein the first housing part is arranged for guiding the tension cords along the underside thereof and wherein the second housing part is arranged for guiding the tension cords along the upper side thereof.

4. A tensioned Venetian blind system according to claim 3, wherein the head rail is provided with an aperture at the location of the tilt mechanism wherein the second housing part is releasably attachable to the head rail for closing the aperture.

5. A tensioned Venetian blind system according to claim 1, wherein in the rails one or more friction components are arranged for guiding the tension cords, wherein the friction components are provided with a second housing, comprising a third and a fourth cooperating housing part releasably attachable to each other for enclosure of the tension cords, wherein the third housing part is arranged for guiding the tension cords along the underside thereof and wherein the fourth housing part is arranged for guiding the tension cords along the upper side thereof.

6. A tensioned Venetian blind system according to claim 3, wherein the housing parts are provided with one or more roll axes for guiding the tension cords.

7. A tensioned Venetian blind system according to claim 3, wherein the cooperating housing parts are shaped complementarily.

8. A tensioned Venetian blind system according to claim 3, wherein the cooperating housing parts are generally wedge-shaped.

9. A tensioned Venetian blind system according to claim 1, wherein a transmission is arranged in the housing of the tilt mechanism, comprising a cooperating worm and worm wheel, wherein the worm wheel is arranged on the tilt rod and wherein the tilt mechanism comprises means for operating the worm.

10. A tensioned Venetian blind system according to claim 9, wherein the operating means comprises a button that preferably is releasably attachable to the tilt mechanism.

11. A tensioned Venetian blind system according to claim 1, wherein the slats are provided with through holes at the position of the ladder cords, wherein the tension cords run between the head rail and the bottom rail through the through holes in the slats.
